(19) United States
(12) Patent Application Publication
(10) Pub. No.: US 2020/0117715 A1
(43) Pub. Date: Apr. 16, 2020

(54) METHOD AND DEVICE FOR TRAINING NEURAL MACHINE TRANSLATION MODEL FOR IMPROVED TRANSLATION PERFORMANCE

(71) Applicant: ELECTRONICS AND TELECOMMUNICATIONS RESEARCH INSTITUTE, Daejeon (KR)

(72) Inventors: Yo Han LEE, Siheung-si (KR); Young Kil KIM, Daejeon (KR)

(21) Appl. No.: 16/558,459

(22) Filed: Sep. 3, 2019

(30) Foreign Application Priority Data
Oct. 10, 2018 (KR) 10-2018-0120554

(51) Int. Cl. G06F 17/28; G06N 3/08

(52) U.S. Cl. CPC G06F 17/2854; G06N 3/08; G06F 17/2836

(57) ABSTRACT

A method and a device for training a neural machine translation model to ensure high translation performance even in a language pair or a domain having a small amount of parallel corpora and solving the problems of over-translation and under-translation caused by the inaccuracy of word-alignment information of an attention network. To this end, bidirectional neural machine translation models are built, and single language corpora are made available for training on the basis of symmetric relation between the models. Also, incomplete alignment information between attention networks of the bidirectional neural machine translation models is normalized to have orthogonal relation so that accurate alignment information may be learned.

### CROSS-REFERENCE TO RELATED APPLICATION

This application claims priority to and the benefit of Korean Patent Application No. 10-2018-0120554, filed 10 Oct. 2018, the disclosure of which is incorporated herein by reference in its entirety.

### BACKGROUND

### 1. Field of the Invention

The present invention relates to neural machine translation (NMT). More particularly, the present invention relates to a neural machine translation model training method and device for obtaining excellent performance and accurate translation results by making it possible to additionally use a single language corpus for training on the basis of a symmetric relationship between bidirectional neural machine translation models and normalizing alignment information of attention networks to have orthogonal relation.

### 2. Description of Related Art

A neural machine translation model simultaneously trains an encoder network which models a first language, a decoder network which models a second language, and an attention network which models word alignment information between the first language and the second language and translates the first language into the second language.

According to existing neural machine translation model training methods, each translation model is independently trained. Therefore, in the case of training a first-to-second language translation model and a second-to-first language translation model, it is not possible to use the symmetric relation between the two translation models. Also, since existing neural machine translation models are dependent on a training corpus, it is not possible to ensure translation performance of the models in a language pair or a domain having a small amount of parallel corpora. Therefore, it is necessary to expand parallel corpora of the corresponding language pair or domain, which requires very high cost.

Further, since word alignment information of an attention network is incomplete or inaccurate, it is not possible to ensure certain accuracy in translation, and the problems of over-translation and under-translation occur.

### SUMMARY OF THE INVENTION

The present invention is directed to ensuring high translation performance in a language pair or a domain having a small amount of parallel corpora and solving the problems of over-translation and under-translation caused by the inaccuracy of word-alignment information of an attention network.

The present invention is also directed to providing a neural machine translation model training method which may be used to verify currently provided neural machine translation service models.

Since an encoder network and a decoder network model a language in different ways, there is no symmetric relationship between the networks. However, attention networks learn word-alignment information between first and second languages, and therefore symmetric relationship is present between the attention networks. Also, an attention network modeled on the basis of an encoder network and a decoder network has great influence on training and translation performance. When alignment information is normalized using symmetric relation, it is possible to efficiently reduce modeling errors of all the networks.

To achieve the aforementioned objectives, bidirectional neural machine translation models are built, and single language corpora are made available for training on the basis of symmetric relation between the models. Also, incomplete alignment information of attention networks in bidirectional neural machine translation models is normalized to have orthogonal relation so that accurate alignment information may be learned.

According to an aspect of the present invention, there is provided a method of training a neural machine translation model including a first-to-second language translation model including a first attention network and a second-to-first language translation model including a second attention network, the method including inputting a second language output from the first-to-second language translation model to the second-to-first language translation model and outputting a translated first language, and comparing a distribution of the first language output from the second-to-first language translation model with a distribution of a first language sentence input to the first-to-second language translation model and transferring a distribution error to the first-to-second language translation model and the second-to-first language translation model.

The method may further include normalizing alignment information of the first and second attention networks to have orthogonal relation. The normalizing of the alignment information may include defining a loss function of each of the first-to-second language translation model and the second-to-first language translation model so that output vectors of the respective models have orthogonal relation with each other, and training each of the models with the loss function.

According to another aspect of the present invention, there is provided a device for training a neural machine translation model, the device including: a first-to-second language translation model configured to translate an input first language into a second language and output the second language; a second-to-first language translation model configured to translate the second language output from the first-to-second language translation model into the first language and output the first language; a means for comparing a distribution of the first language output from the second-to-first language translation model with a distribution of the first language input to the first-to-second language translation model; and a means for transferring an error obtained through the comparison to the first-to-second language translation model and the second-to-first language translation model.

In this device, the first-to-second language translation model may include a first encoder network for receiving the first language as an input and modeling the first language, a first decoder network for modeling the second language, and a first attention network for modeling word alignment information between the first language and the second language, and the second-to-first language translation model may include a second encoder network for receiving the second language as an input and modeling the second language, a second decoder network for modeling the first language, and a second attention network for modeling word alignment information between the second language and the first language.

In this case, the device may additionally include a means for normalizing alignment information of the first and second attention networks to have orthogonal relation. The normalization means may define a loss function of each of the first-to-second language translation model and the second-to-first language translation model so that output vectors of the respective models have orthogonal relation with each other, and may train each of the models with the loss function.

According to another aspect of the present invention, there is provided a method of verifying a first-to-second language translation model including a first attention network, the method including: inputting a second language output from the first-to-second language translation model to a second-to-first language translation model including a second attention network and outputting a translated first language; and comparing a distribution of the first language output from the second-to-first language translation model with a distribution of a first language sentence input to the first-to-second language translation model and transferring a distribution error to the first-to-second language translation model and the second-to-first language translation model.

The above-described configuration and operation of the present invention will become more apparent from the following detailed description of embodiments and drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing a configuration of an existing unidirectional, first-to-second language, neural machine translation model;

FIG. 2 is an example view of over-translations and under-translations;

FIG. 3 is a diagram showing a configuration of bidirectional neural machine translation models according to an exemplary embodiment of the present invention;

FIG. 4 is a diagram illustrating the concept of orthogonal relation normalization of respective pieces of attention network alignment information of the bidirectional neural machine translation models of FIG. 3; and

FIGS. 5A to 5C show examples illustrating the concept of orthogonal relation normalization in the case of an English (E)-French (F) translation model.

### DETAILED DESCRIPTION OF EXEMPLARY EMBODIMENTS

Advantages and features of the present invention and method for achieving them will be made clear from embodiments described below in detail with reference to the accompanying drawings. However, the present invention may be embodied in many different forms and should not be construed as being limited to the embodiments set forth herein. Rather, these embodiments are provided so that this disclosure will be thorough and complete, and will fully convey the scope of the present invention to those of skilled in the art to which the present invention pertains. The present invention is merely defined by the claims.

Terms used herein are for the purpose of describing embodiments only and are not intended to limit the present invention. As used herein, the singular forms are intended to include the plural forms as well unless the context clearly indicates otherwise. The terms “comprise” or “comprising” used herein indicate the presence of disclosed elements, steps, operations, and/or devices and do not preclude the presence or addition of one or more other elements, steps, operations, and/or devices.

Hereinafter, exemplary embodiments of the present invention will be described in detail. It should be noted that in giving reference numeral to elements of each drawing, like reference numeral refer to like elements even through like elements are shown in different drawings. While describing the present invention, detailed descriptions of related well-known configurations or functions are omitted when determined to obscure the gist of the present invention.

According to the present invention, for each language sentence, bidirectional neural machine translation models are built, and an auto-encoder training method is used During training of the neural machine translation models, one language corpus is restored through the bidirectional neural machine translation models. Then, languages output from the respective models are compared with each other and learned, and alignment information of attention networks included in the respective translation models is normalized to have orthogonal relation, such that objectives of the present invention may be achieved.

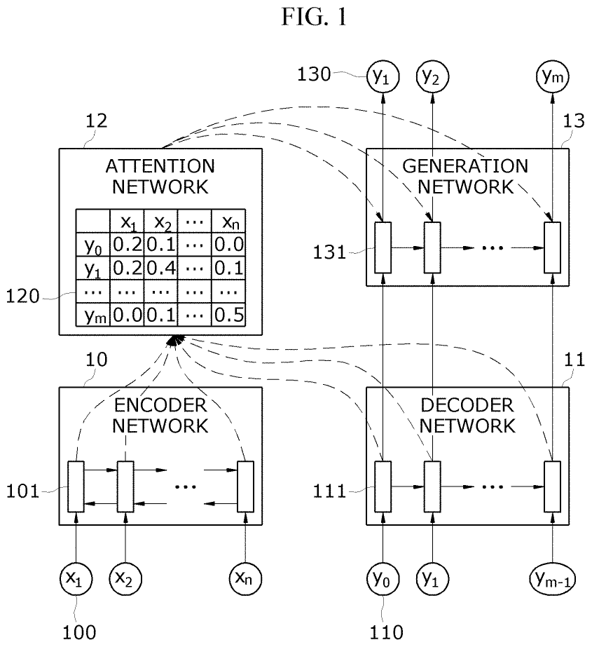

First, a method of training a general unidirectional, first-to-second language, neural machine translation model will be described with reference to the diagram of a model shown in FIG. 1.

A unidirectional neural machine translation model of FIG. 1 is composed of an encoder network 10 which models a first language (i.e., a source language), a decoder network 11 which models a second language (i.e., a target language), an attention network 12 which models word alignment information between the first language and the second language, and a generation network 13.

A hidden state vector 101 of the encoder network 10 is determined by a first language input token 100. Likewise, a hidden state vector 111 of the decoder network 11 is determined by a second language input token 110.

The attention network 12 determines soft alignment information 120 between the first language input token 100 and the second language input token 110 from the respective hidden state vectors of the encoder network 10 and the decoder network 11. In other words, the attention network 12 sets up relation between the encoder network 10 and the decoder network 11 and outputs a matrix of the soft alignment information matrix 120 in which the relation has been set up.

The generation network 13 generates distribution information 131 of second language tokens, that is, token probability distributions, by combining the hidden state vectors 101 and 111 of the encoder network 10 and the decoder network 11 with the determined soft alignment information 120, and it compares the distribution information 131 with a second language output token 130.

A loss function for training such a neural machine translation model may be defined as the cross entropy between the distribution information 131 of second language tokens and a second language output token distribution 130 as shown in the following equation.

Loss=−Σₜ₌₁^{T}Σₖ₌₁^{|V|}1{yₜ=k}×Log p(yₜ=k|x;θ) [Equation 1]

In Equation 1, t is a step index, k is a token index, |V| is a total number of tokens, 1{yₜ=k} is the second language output token distribution 130 at a step t, x is an input sentence, θ is a model parameter, and p is the token probability distribution 131 of the model.

A log likelihood of Equation 2 below briefly represents a model-specific loss function of Equation 1.

Loss=−log p(y|x;θ₁)−log p(x|y;θ₂)s·t A^{T}B=I[Equation 2]

In Equation 2, A is an alignment information matrix of a first-to-second language neural machine translation model, and B is an alignment information matrix of a second-to-first language neural machine translation model.

Meanwhile, the second-to-first language neural machine translation model is also built as the unidirectional neural machine translation model shown in FIG. 1.

Such an existing unidirectional neural machine translation model is trained using parallel corpora between the first and second languages. However, in a language pair or a domain having a small amount of parallel corpora, it is not possible to ensure translation performance of the model. Accordingly, in the present invention, a single corpus (a corpus only consisting of the first language or the second language) which is easy to build as compared to a parallel corpus is used for training on the basis of the symmetric relationship between bidirectional neural machine translation models. In other words, results obtained by translating a first language corpus with the first-to-second language translation model are translated again with the second-to-first language translation model, and the first-to-second language translation model and the second-to-first language translation model are trained so that a difference between a final result language and an input language may be reduced (will be described in detail below).

Meanwhile, in the attention network 12 of the unidirectional neural machine translation model of FIG. 1, alignment information between first and second language tokens is modeled on the basis of the hidden state vectors 101 and 111 of the encoder network 10 and the decoder network 11 and thus has great influence on training and translation performance. When alignment information is inaccurate, the problems of over-translation and under-translation frequently occur.

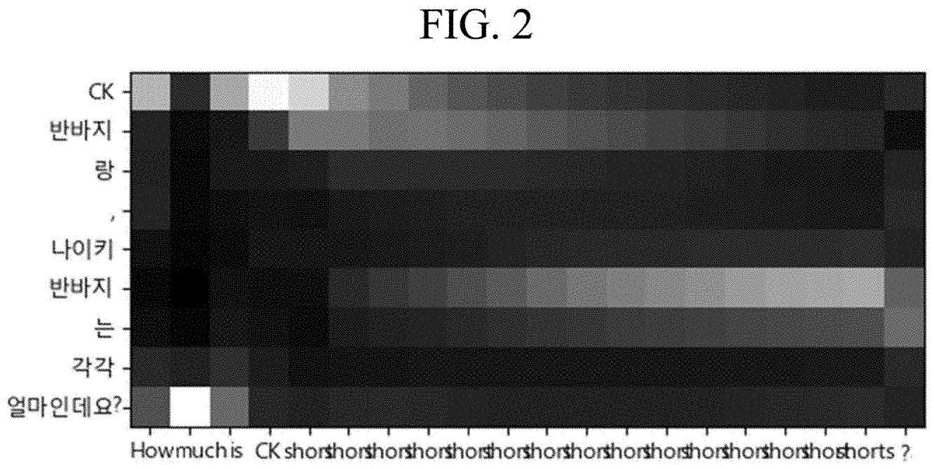

FIG. 2 shows examples of over-translation and under-translation. FIG. 2 shows weight scores in an attention network. Bright portions indicate high scores, and dark portions indicate low scores. In the case of translating the Korean sentence “CK [symbol] [symbol] [symbol] ?”, which means “How much is CK shorts and Nike shorts respectively?” and reads “CK pan-ba-ji rang, Nike pan-ba-ji nun kak-gak ol-ma-in-de-yo?”, into English as shown in FIG. 2, the Korean sentence is over-translated into the English sentence “How much is CK shorts shorts shorts shorts . . . ?” because “ [symbol] ” (means “shorts”) has a higher alignment weight than other tokens almost always in every translation step. Also, “ [symbol] ” (means “Nike”) is not translated (under-translation) because it always has a low alignment weight in every translation step. The reason is inaccuracy in alignment information.

In the attention networks of the first-to-second language neural machine translation model and of the second-to-first language neural machine translation model, alignment information between first and second language tokens is in symmetric relation. If a penalty is given to one token with a high alignment weight in the alignment information in every translation step, it will be possible to mitigate the problems of over-translation and under-translation. Therefore, in the present invention, it is intended to obtain more accurate alignment information by normalizing alignment information of two neural machine translation models to have orthogonal relation (see description below), which can be defined as a loss function without changing a neural network model and will accordingly become efficient.

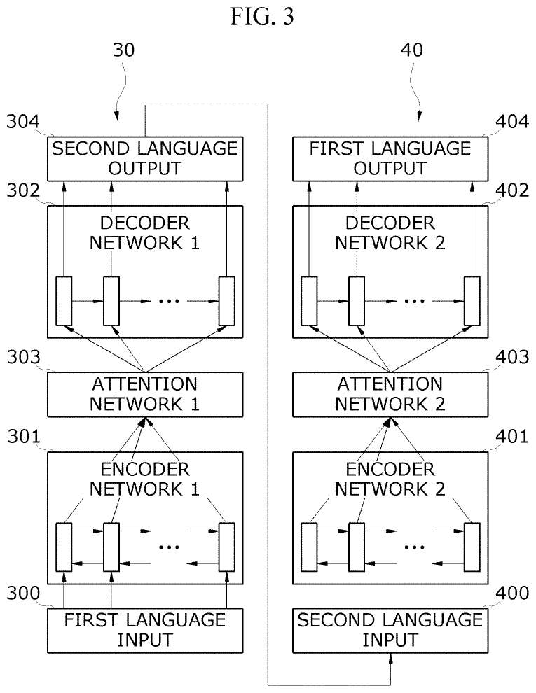

FIG. 3 is a diagram showing a configuration of the present invention for using a single language corpus, which is easy to build as compared to a parallel corpus, for training on the basis of the symmetric relationship between bidirectional neural machine translation models. FIG. 3 illustrates a process of training bidirectional neural machine translation models using first language corpora.

A bidirectional auto-encoder training method is used for each language sentence, and during training of the neural machine translation model a single language corpus is restored through bidirectional neural machine translation model and thereafter it is trained so that high translation performance may be ensured at low cost even in a language pair or a domain having a small amount of parallel corpora.

A first-to-second language translation model 30 shown on the left receives a first language as an input 300, builds an attention network 303 on the basis of an encoder network 301 modeling the first language and a decoder network 302 modeling a second language, and outputs the second language (304). Symmetrically, a second-to-first language translation model 40 shown on the right receives the second language as an input 400, builds an attention network 403 on the basis of an encoder network 401 modeling the second language and a decoder network 402 modeling the second language, and outputs the first language (404).

In brief, a second language sentence output (304) from the first-to-second language translation model 30 is output (404) in the first language again through the second-to-first language translation model 40. A distribution of the output first language sentence 404 (where the second-to-first language translation model 40 predicts first language words to be positioned in each step and prediction results are represented as probability distribution values regarding a predefined vocabulary) is compared with a distribution of an input first language sentence 300 (probability distribution of actual first language words positioned in each step; e.g., Assuming a predefined vocabulary is [a, b, c, d, e], a probability distribution regarding the word d is [0, 0, 0, 1, 0]), and the distribution error is transferred to the two translation models 30 and 40. A difference between the two distributions may be measured as cross entropy as shown in Equation 1, and the measured value is an error of the models 30 and 40. In other words, an error of the models 30 and 40 may be defined as a difference between a predicted word distribution and an actual word distribution.

A second language corpus may also be used for model training in the above manner. In other words, a second language corpus is input to the second-to-first language translation model and translated into the first language, and when the first language is translated with the first-to-second language translation model, a second language sentence is obtained. The finally output second language sentence is compared with an input second language sentence, and two translation models are trained so that the error may be reduced.

Since a single language corpus which is relatively easy to build may be used for training the bidirectional neural machine translation models on the basis of the symmetric relationship between the models, translation performance of the models may be improved even in a language pair or a domain having a small amount of parallel corpora.

Also, the bidirectional neural machine translation models learn symmetric relationship between first and second languages. Therefore, when an output of a first-to-second language translation model is restored with a counterpart translation model, the result tends to be substantially the same as a first language input. Therefore, the above method may be used to test or verify neural network models which translate first and second languages among currently provided neural machine translation models.

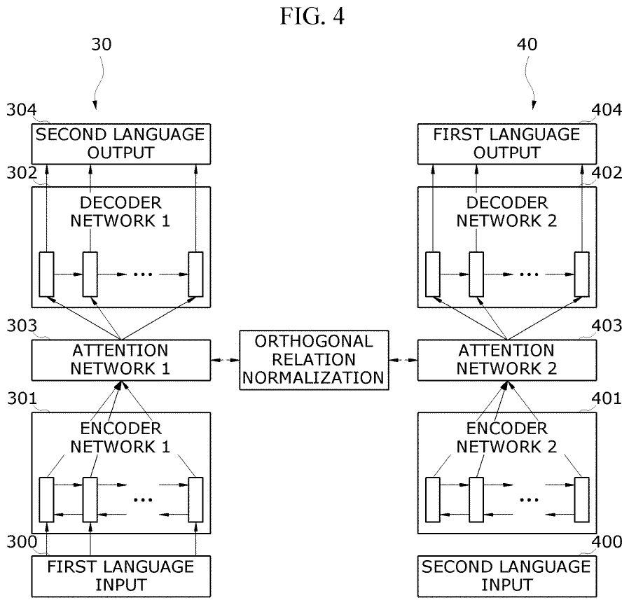

FIG. 4 is a diagram illustrating the concept of orthogonal relation normalization of respective pieces of attention network alignment information of the bidirectional neural machine translation models of FIG. 3. The concept of the invention shown in FIG. 4 is to define a loss function (e.g., the function of Equation 3) such that output vectors of the first-to-second language translation model 30 and the counterpart second-to-first language translation model 40 have orthogonal relation with each other, and to cause the loss function to be learned.

A loss function in training the bidirectional neural machine translation models of FIG. 4 with single language corpora may be defined, for example, as shown in Equation 3 below.

Loss=−log p(y|x;θ₁)−log p(x|y;θ₂)−log p(x̅′̅|x̅;θ₁,θ₂)−log p(y̅′̅|y̅;θ₁,θ₂)s·t A^{T}B=1 [Equation 3]

In Equation 3, x̅, y̅ are single corpus of first and second languages, respectively, and x̅′y̅′ are first and second language sentences obtained through bidirectional neural machine translation models, respectively.

During a training process, a process of inputting a sentence output from the first-to-second language translation model 30 to the counterpart model 40 is discontinuous, and thus generally a gradient cannot be transferred. Therefore, it is necessary to measure a gradient between the two models using a sampling-based method and transfer the gradient.

Meanwhile, a representative method of sampling a translation sentence from a neural machine translation model is a method based on beam search. Therefore, Equation 3 may be represented by Equation 4 below.

Loss=−log p(y|x;θ₁)−log p(x|y;θ₂)−log Σ_{y̅},p(x̅′̅|y̅′̅;θ₂)p(y̅′̅|x̅;θ₁)−log Σ_{x̅′̅},p(y̅′̅|x̅′̅;θ₁)p(x̅′̅|y̅;θ₂)s,t A^{T}B=1 [Equation 4]

Orthogonal relation between the attention networks in the bidirectional neural machine translation models of FIG. 4 is as follows.

Assuming that a first language sentence is composed of tokens [sw₁, sw₂, sw₃] and a second language sentence is composed of tokens [twᵢ, tw₂, tw₃, tw₄], a first-to-second language (source-to-target) alignment score matrix A is

$${tw}_{1} {tw}_{2} {tw}_{3} {tw}_{4}$$

$$\begin{matrix}{sw}_{1} \\ {sw}_{2} \\ {sw}_{3}\end{matrix} ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34}\end{matrix} ) ,$$

and a second-to-first language (target-to-source) alignment score matrix B is

$${sw}_{1} {sw}_{2} {sw}_{3}$$

$$\begin{matrix}{tw}_{1} \\ {tw}_{2} \\ {tw}_{3} \\ {tw}_{4}\end{matrix} ( \begin{matrix}{b}_{11} & {b}_{12} & {b}_{13} \\ {b}_{21} & {b}_{22} & {b}_{23} \\ {b}_{31} & {b}_{32} & {b}_{33} \\ {b}_{41} & {b}_{42} & {b}_{43}\end{matrix} ) .$$

Accordingly, the first-to-second language translation model 30 and the second-to-first language translation model 40 have the above attention information.

A product of attention matrices of the two models is calculated as follows.

$$\begin{matrix}BA = {sw}_{1} {sw}_{2} {sw}_{3} \\ \begin{matrix}{tw}_{1} \\ {tw}_{2} \\ {tw}_{3} \\ {tw}_{4}\end{matrix} ( \begin{matrix}{b}_{11} & {b}_{12} & {b}_{13} \\ {b}_{21} & {b}_{22} & {b}_{23} \\ {b}_{31} & {b}_{32} & {b}_{33} \\ {b}_{41} & {b}_{42} & {b}_{43}\end{matrix} ) \cdot \\ {tw}_{1} {tw}_{2} {tw}_{3} {tw}_{4} \\ \begin{matrix}{sw}_{1} \\ {sw}_{2} \\ {sw}_{3}\end{matrix} ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34}\end{matrix} ) \\ = ( \begin{matrix}{tw}_{1} \vert s & {tw}_{1} , {tw}_{2} \vert s & {tw}_{1} , {tw}_{3} \vert s & {tw}_{1} , {tw}_{4} \vert s \\ {tw}_{2} , {tw}_{1} \vert s & {tw}_{2} \vert s & {tw}_{2} , {tw}_{3} \vert s & {tw}_{2} , {tw}_{4} \vert s \\ {tw}_{3} , {tw}_{1} \vert s & {tw}_{3} , {tw}_{2} \vert s & {tw}_{3} \vert s & {tw}_{3} , {tw}_{4} \vert s \\ {tw}_{4} , {tw}_{1} \vert s & {tw}_{4} , {tw}_{2} \vert s & {tw}_{4} , {tw}_{3} \vert s & {tw}_{4} \vert s\end{matrix} )\end{matrix}$$

The product of the two attention matrices is made close to a unit matrix as follows.

$$BA = ( \begin{matrix}{tw}_{1} \vert s & {tw}_{1} , {tw}_{2} \vert s & {tw}_{1} , {tw}_{3} \vert s & {tw}_{1} , {tw}_{4} \vert s \\ {tw}_{2} , {tw}_{1} \vert s & {tw}_{2} \vert s & {tw}_{2} , {tw}_{3} \vert s & {tw}_{2} , {tw}_{4} \vert s \\ {tw}_{3} , {tw}_{1} \vert s & {tw}_{3} , {tw}_{2} \vert s & {tw}_{3} \vert s & {tw}_{3} , {tw}_{4} \vert s \\ {tw}_{4} , {tw}_{1} \vert s & {tw}_{4} , {tw}_{2} \vert s & {tw}_{4} , {tw}_{3} \vert s & {tw}_{4} \vert s\end{matrix} ) \approx ( \begin{matrix}1 & 0 & 0 & 0 \\ 0 & 1 & 0 & 0 \\ 0 & 0 & 1 & 0 \\ 0 & 0 & 0 & 1\end{matrix} )$$

Here are two conditions for orthogonal relation normalization. First, when an i^{th} column of A and an i^{th} row of B have the same order of value, the condition of twᵢ|S≈1→a₁ᵢ b₁ᵢ+a₂ᵢ bᵢ₂+a₃ᵢ bᵢ₂≈1 is satisfied. In other words, it is possible to adjust each other's wrong attention information (intersection effects). Second, when an attention correlation between twⱼ and twⱼ is removed, that is, in the case of twᵢ, twⱼ|S(i≠j)≈0, it is possible to prevent one word from having high attention scores among several target words (mitigation of over-translation and under-translation).

To meet these conditions for orthogonal relation normalization, the models are trained to minimize the loss function as shown in Equation 5.

Loss=−log p(y|x;θ)+∥I−BA∥₂² [Equation 5]

In Equation 5, the first term is a loss (translation accuracy) of existing NMT (neural machine translation), and the second term is attention orthogonal relation normalization according to the present invention. Therefore, Equation 5 represents that translation accuracy is further improved by adding orthogonal relation normalization of alignment information of attention networks to existing NMT.

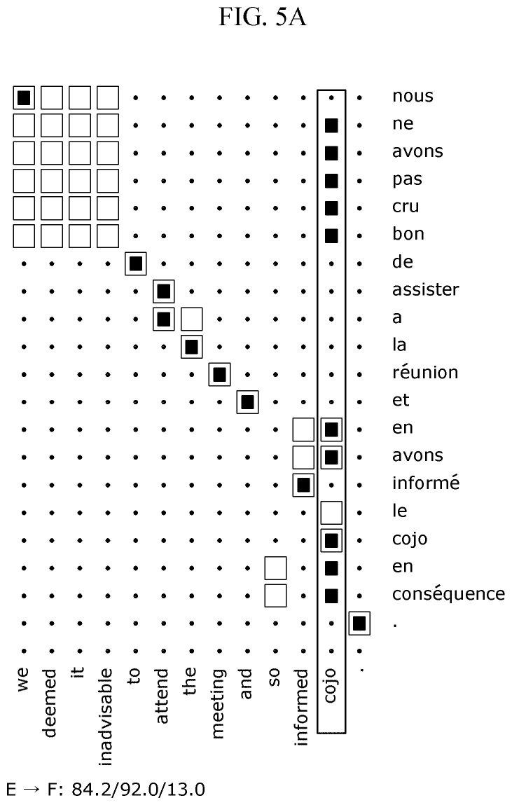

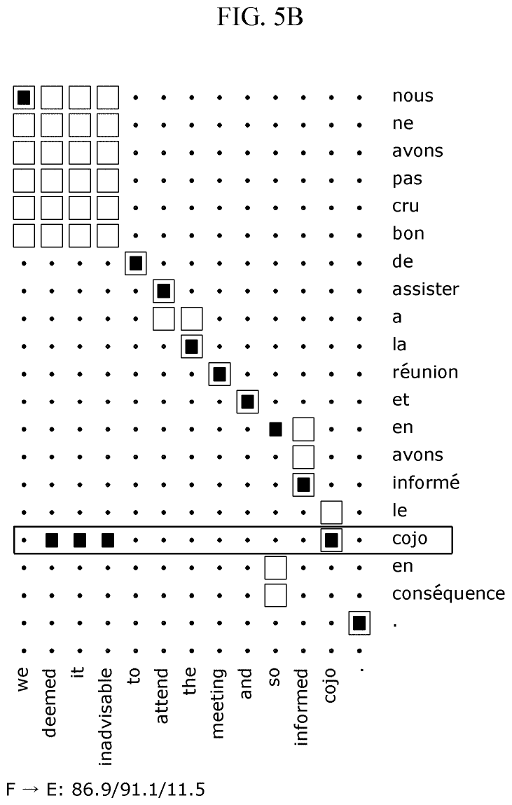

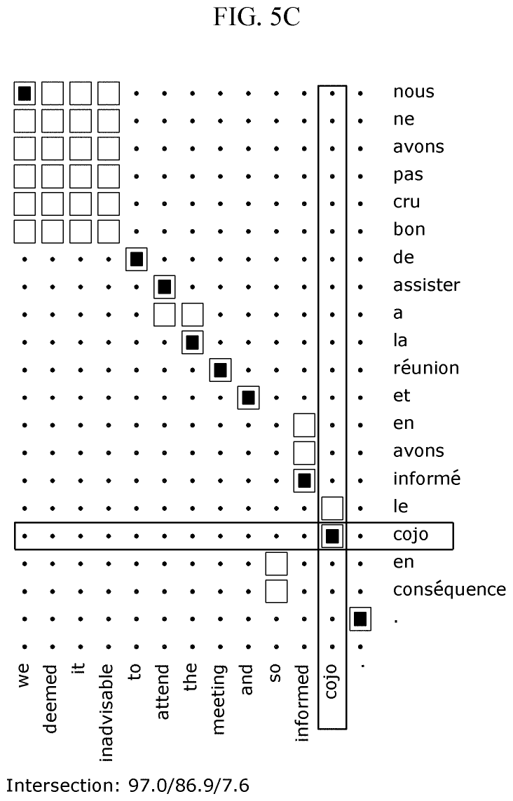

FIGS. 5A to 5C illustrate results of orthogonal relation normalization with an example of an English (E)-to-French (F) translation model. In these drawings, the x-axis indicates an English sentence, and the y-axis indicates a French sentence.

In the E-to-F model of FIG. 5A, the English word “cojo” has high attention scores among many French words. Likewise, in the F-to-E model of FIG. 5B, the French word “cojo” has high attention scores among many English words. Therefore, the two models are highly likely to derive wrong translation results. To solve such a problem, finding an intersection of the two attention networks as shown in FIG. 5C makes it possible to correct wrong attention information (in the case of using an intersection as described above, accuracy is improved, and an alignment error rate (AER) is reduced).

In FIGS. 5A to 5C, solid line boxes are shown to emphasize distributions of correlations between “cojo” and counterpart words, and numbers 84.2/92.0/13.0, 86.9/91.1/11.5, and 97.0/86.9/7.6 written under FIGS. 5A to 5C indicate precision/recall/AER of alignment information in a test set.

The present invention can be implemented in a device aspect or a methodological aspect. In particular, a function or a process of each element in an exemplary embodiment of the present invention can be implemented as at least one of a digital signal processor (DSP), a processor, a controller, an application-specific integrated circuit (ASIC), a programmable logic element (a field-programmable gate array (FPGA) or the like), and other electronic elements and a hardware element including a combination thereof. Also, a function or a process of each element can be implemented as software in combination with or independently from a hardware element, and the software can be stored in a recording medium.

According to the present invention, alignment information of attention networks included in respective bidirectional neural machine translation models is normalized to have orthogonal relation so that accurate alignment information may be learned. Therefore, it is possible to mitigate the problem of over-translation or under-translation which frequently occurs in existing neural machine translation models.

Also, single language corpora may be additionally used for training on the basis of a symmetric relationship between bidirectional neural machine translation models. Therefore, even in a language pair or a domain having a small amount of parallel corpora, it is possible to build a neural machine translation model which ensures high translation performance at low cost.

A method of training bidirectional neural machine translation models according to an exemplary embodiment of the present invention does not require a change in existing neural machine translation models and thus may be efficiently implemented.

Since neural machine translation models output natural translation results as compared to existing rule-based machine translation models or statistical machine translation models, most current translation services are based on neural machine translation models. Neural machine translation models require an attention network to yield higher translation performance than existing translation models, and it is possible to improve translation performance through an attention network with high accuracy. Also, even in a field in which neural machine translation models are not able to replace existing translation models due to a small amount of parallel corpora, a method of training a neural machine translation model according to an exemplary embodiment of the present invention may be used instead of existing translation models.

A configuration of the present invention has been described in detail above according to exemplary embodiments of the present invention. However, those of ordinary skill in the art to which the present invention pertains should understand that the present invention can be implemented in a specific form other than those disclosed herein without departing from the technical spirit of the present invention or changing fundamental characteristics of the present invention. It should be understood that the disclosed embodiments of the present invention are exemplary in all aspects and not limiting. The scope of the present invention is defined by the following claims rather than the above detailed descriptions, and it should be understood that the present invention encompasses all alterations or modifications derived from the claims and the equivalents thereof

What is claimed is:

1. A method of training a neural machine translation model including a first-to-second language translation model including a first attention network and a second-to-first language translation model including a second attention network, the method comprising:
inputting a second language output from the first-to-second language translation model to the second-to-first language translation model and outputting a translated first language; and
comparing a distribution of the first language output from the second-to-first language translation model with a distribution of a first language sentence input to the first-to-second language translation model and transferring a distribution error to the first-to-second language translation model and the second-to-first language translation model.

2. The method of claim 1, wherein the comparing of the two distributions comprises comparing the two distributions using cross entropy.

3. The method of claim 1, further comprising normalizing alignment information of the first and second attention networks to have orthogonal relation.

4. The method of claim 3, wherein the normalizing of the alignment information comprises defining a loss function of each of the first-to-second language translation model and the second-to-first language translation model so that output vectors of the respective models have orthogonal relation with each other, and training each of the models with the loss function.

5. A device for training a neural machine translation model, the device comprising:
a first-to-second language translation model configured to translate an input first language into a second language and output the second language;
a second-to-first language translation model configured to translate the second language output from the first-to-second language translation model into the first language and output the first language;
a means for comparing a distribution of the first language output from the second-to-first language translation model with a distribution of the first language input to the first-to-second language translation model; and
a means for transferring an error obtained through the comparison to the first-to-second language translation model and the second-to-first language translation model.

6. The device of claim 5, wherein the first-to-second language translation model comprises:
a first encoder network configured to receive the first language as an input and model the first language;
a first decoder network configured to model the second language; and
a first attention network configured to model word alignment information between the first language and the second language, and
the second-to-first language translation model comprises:
a second encoder network configured to receive the second language as an input and model the second language;
a second decoder network configured to model the first language; and
a second attention network configured to model word alignment information between the second language and the first language.

7. The device of claim 5, further comprising a means for normalizing alignment information of the first and second attention networks to have orthogonal relation.

8. The device of claim 7, wherein the normalization means defines a loss function of each of the first-to-second language translation model and the second-to-first language translation model so that output vectors of the respective models have orthogonal relation with each other, and trains each of the models with the loss function.

9. A device for training a neural machine translation model, the device comprising:
a first-to-second language translation model configured to translate the input first language into the second language and output the second language, the first-to-second language translation model comprising a first encoder network for receiving a first language as an input and modeling the first language, a first decoder network for modeling a second language, and a first attention network for modeling word alignment information between the first language and the second language, and;
a second-to-first language translation model configured to translate the second language output from the first-to-second language translation model into the first language and output the first language, the second-to-first language translation model comprising a second encoder network for receiving the second language as an input and modeling the second language, a second decoder network for modeling the first language, and a second attention network for modeling word alignment information between the second language and the first language, and; and
a means for normalizing alignment information of the first and second attention networks to have orthogonal relation.

10. The device of claim 9, wherein the normalization means defines a loss function of each of the first-to-second language translation model and the second-to-first language translation model so that output vectors of the respective models have orthogonal relation with each other, and trains each of the models with the loss function.

11. The device of claim 9, further comprising:
a means for comparing a distribution of the first language output from the second-to-first language translation model with a distribution of the first language input to the first-to-second language translation model; and
a means for transferring an error obtained through the comparison to the first-to-second language translation model and the second-to-first language translation model.
